(19) United States
(12) Patent Application Publication
(10) Pub. No.: US 2026/0247475 A1
(43) Pub. Date: Aug. 20, 2026

(54) SYSTEM FOR ENHANCING C-DRX ENERGY SAVINGS BY WAKE-UP DESYNCHRONIZATION IN XR DEVICES AND A METHOD THEREOF

(71) Applicant: INDIAN INSTITUTE OF TECHNOLOGY KHARAGPUR, KHARAGPUR (IN)

(72) Inventors: SOURAV DUTTA, Kharagpur (IN); DIBBENDU ROY, Kharagpur (IN); GOUTAM DAS, Kharagpur (IN)

(21) Appl. No.: 19/054,186

(22) Filed: Feb. 14, 2025

(51) Int. Cl. H04W 76/28; H04W 52/02; H04W 72/23

(52) U.S. Cl. CPC H04W 76/28; H04W 52/0235; H04W 72/23

(57) ABSTRACT

The present invention is directed to saving energy in wireless including 5G user equipment's (UEs). The system of the present invention for enhancement of Connected mode Discontinuous Reception (C-DRX) energy savings through wake-up Desynchronization of extended reality (XR) user equipments (UEs) under wireless communication comprises control unit for gNB and said UEs. The control unit includes gNB radio resource control (RRC) for setting C-DRX parameters which includes drx-dsync-offset and informing MAC unit to implements the de-synchronization with help of a PDCCH signal that sent in downstream for control. The UEs read said PDCCH signal for information regarding the drx-dsync-offset and operate in wake-up slots according to the de-synchronization implemented at the MAC unit to start reading the PDCCH signal after a duration of drx-dsync-offset.

### FIELD OF THE INVENTION

The present invention relates to a system and method for enhancement of Connected mode Discontinuous Reception (C-DRX) energy savings by wake-up Desynchronization in XR. More specifically, the present invention relates to advancement in system and method for saving energy in 5G UE.

### BACKGROUND OF THE INVENTION

The C-DRX method represents one of the most fundamental power-saving techniques for User Equipments (UEs). In C-DRX energy saving is achieved by cyclically transitioning between active and sleep modes. During sleep mode, UEs are incapable of receiving PDCCH, consequently impeding data transfer. Thus, UEs periodically emerge from sleep mode, remaining in an active state for a minimum duration, termed as “drx on duration.” This sequence, encompassing both active and sleep phases, constitutes a “drx cycle.” The Radio Resource Control (RRC) layer of the gNB configures these parameters through the ‘drx-LongCycle’ and ‘drx-onDuration’ fields of the RRC message. The C-DRX on duration may not necessarily start at the beginning of the C-DRX cycle. The RRC layer also configures this offset using the ‘drx-LongCycleStartOffset’ and ‘drx-SlotOffset’ fields of the RRC message, which define the initial sub-frame of the C-DRX on duration and the starting slot of the C-DRX ON duration from the beginning of that sub-frame, respectively. If a user fails to receive its PDCCH signal during the C-DRX on period, it implies that the gNB lacks data for that user. Consequently, the user enters sleep mode, remaining in this state until the next C-DRX on duration begins. On the other hand, if the user successfully receives the PDCCH signal, it indicates the presence of data from the gNB. Thus, all the data must be cleared before the user re-enters sleep mode, which may not always be possible within the C-DRX ontimer. Thus, a new timer is introduced, namely ‘drx inactivity timer.’ Upon receiving a PDCCH, the user activates the C-DRX inactivity timer, subsequently resetting it after each PDCCH reception. If the C-DRX inactivity timer elapses, the user transitions into sleep mode. The C-DRX inactivity timer is configured by the ‘drx-InactivityTimer’ field of the RRC message.

S. C. Sundararaju et al., (2020) IEEE 3rd 5G World Forum (5GWF), page 318-323, proposed a mechanism called UCM (UE defined C-DRX for MSMS UEs). UEs shall optimally compute C-DRX configuration based on overall RFIC ON duration considering the events of other SIMs too and share it with 5G networks. Key Performance Indicators (sleep ratio and mean packet buffering delay) of the new CDRX mechanism are qualitatively compared with the legacy. Results reveal that UCM achieves better power saving with little increase in packet latency. The prior art fails to disclose a method involving wake-up de-synchronization for improving energy savings and poses restriction of allocating a TTI to a single user.

F. Moradi et al., (2017) 15th International Symposium on Modeling and Optimization in Mobile, Ad Hoc, and Wireless Networks (WiOpt), page 1-6, discloses joint optimization of Discontinuous Reception (DRX) cycle length and LTE scheduling to minimize mobile devices' energy usage for video delivery, utilising the now well-established potential to predict future channel conditions in cellular networks. Employing in-network caching, a strict buffer constraint was set which provides zero buffer underflow to improve Quality of Experience. The prior art provides insight into the energy saving potential sophisticated DRX schemes hold, compared with the currently used static method. Two DRX approaches were proposed and studied. The results showed that more sophisticated DRX schemes (with variable DRX cycle length) can potentially save 69 percent energy for mobile devices, encouraging further research in the field. Thus the prior art optimally decides the DRX parameters for video transmission in LTE. The prior art assumes that future data rate for a certain time is known and predicting the future channel condition. Further the prior art assumes that a TTI can be allocated to only one user.

The prior art fails to disclose a method involving wake-up de-synchronization for improving energy savings and poses restriction of allocating a TTI to a single user.

F. Moradi et al., (2020) IEEE Transactions on Vehicular Technology, volume. 69 no. 1, page 607-621, discloses the impact of the prediction errors, the size of the prediction window, and the value of the buffer threshold is studied. An online algorithm is proposed to increase robustness against prediction errors, and to provide a dynamically adjustable solution. The prior art fails to disclose a method involving wake-up de-synchronization for improving energy savings and poses restriction of allocating a TTI to a single user.

M. T. Abbas et al., (2020) IEEE 45th LCN Symposium on Emerging Topics in Networking (LCN Symposium), page 60-69, provides guidelines on how to configure the NB-IoT protocol stack in order to save energy. The prior art suggests that key to saving energy for NB-IoT devices is the usage of full Discontinuous Reception (DRX), including the use of connected-mode DRX (cDRX) and that tunable parameters, such as the inactivity timer, do have a significant impact. The prior art does not involve de-synchronized wake-up of UEs. There is no involvement of de-synchronized wake-up of UEs.

J. Yang et al., (2022) IEEE 95th Vehicular Technology Conference: (VTC2022-Spring), page 1-5, studies the effect of C-DRX on latency for Immersive live video of 5G NR. Both the latency and the latency variation increase with a higher video data rate and Block Error Rate. 5G-NR mobility and handover performance are evaluated for a ubiquitous consistent latency. The prior art does not involve de-synchronized wake-up of UEs.

US20220132277A1 relates to a pre-5th generation (5G) or 5G communication system for supporting higher data rates beyond a 4th generation (4G) communication system such as long term evolution (LTE). A method performed by a network entity for handling a multicast and broadcast service (MBS) in a 5G communication network is provided that includes receiving a request for receiving at least one multicast service from a user equipment (UE), which includes at least one of a session join request or a service request, configuring the at least one multicast service based on the request, and sending the at least one multicast service to the UE over a radio resource control (RRC) reconfiguration message, which includes at least one of a point-to-multipoint (PTM) bearer configuration for a point-to-point (PTM) mode, a PTP bearer configuration for a PTP mode, or a split bearer configuration for a split bearer mode. The prior art does not involve de-synchronized wake-up of UEs; is not generic and is specific to multicast/broadcast service.

U.S. Ser. No. 16/300,359 relates to a communication method and system for converging a 5th-Generation (5G) communication system for supporting higher data rates beyond a 4th-Generation (4G) system with a technology for Internet of Things (IoT). The prior art discloses a method for delaying an RRC connection access, a method for entering in early C-DRX or RRC-inactive state, and the like in order to reduce the power consumption of a terminal. The prior art does not involve de-synchronized wake-up of UEs for enhancing C-DRX energy savings.

U.S. Ser. No. 17/218,991 proposed separating out the configuration settings for communication in three different zones or categories based on various requirements like delay budget, bandwidth requirement, throughput etc. The prior art discloses a method of wireless communication including receiving, while in a connected mode, a configuration based on data traffic for the wireless communication device, the configuration indicating: a first zone associated with a first set of operating parameters for the wireless communication device; and a second zone associated with a second set of operating parameters for the wireless communication device, the second set of operating parameters being different than the first set of operating parameters; operating in the first zone with the first set of operating parameters to monitor for a first downlink communication signal; and operating in the second zone with the second set of operating parameters. The prior art does not specify the use of de-synchronized wake-up of UEs. Moreover, in each zone of the prior art, the proposed method of the present invention can be used for further improving energy savings of the prior art.

Thus, there is a need for development of method and system for saving energy in wireless 5G user equipment's (UEs) which has the potential to significantly improve energy efficiency which is essential for wireless devices as they are battery operated. Thus, to address his problem the present invention aims to develop a method and system for enhancement of C-DRX energy savings by wake-up Desynchronization in XR.

### OBJECTS OF THE INVENTION

The basic object of the present invention is thus directed to advancements in a system and method for enhancement of C-DRX energy savings involving wake-up Desynchronization in XR.

Another object of the present invention is to provide a system and method for saving energy in 5G UE which has the potential to save energy by many folds.

A further object of the present invention is to provide a system adapted for implementation of the method enhancement of C-DRX energy savings by wake-up Desynchronization in XR.

Yet another object of the present invention is to provide a low-complexity operability for implementation of the advanced method and system of enhancement of C-DRX energy savings by wake-up Desynchronization in XR.

Another object of the present invention is directed to save considerable UE power during XR sessions.

Yet another object of the present invention is to provide a method and system directed to save power and reduces the operational cost thus making it cost-effective.

### SUMMARY OF THE INVENTION

The present invention relates to a system and method for enhancement of Connected mode Discontinuous Reception (C-DRX) energy savings by wake-up Desynchronization in XR. More specifically, the present invention relates to advancement in system and method for saving energy in 5G UE. The present invention further provides for system modifications required for implementation of the method for enhancement of C-DRX energy savings by wake-up Desynchronization in XR. Advantageously, the present invention also provides for a low-complexity workability for implementation of method for enhancement of C-DRX energy savings by wake-up Desynchonization in XR. Advantageously, the present invention saves power and reduces the operational cost thus making the advancement cost-effective.

Thus, according to the basic aspect of the present invention there is provided a system for enhancement of Connected mode Discontinuous Reception (C-DRX) energy savings through wake-up Desynchronization of extended reality (XR) user equipments (UEs) under wireless communication comprising
control unit for gNB and said UEs;
said control unit includes
gNB radio resource control (RRC) for setting C-DRX parameters which includes drx-dsync-offset and informing MAC unit to implements the de-synchronization with help of a PDCCH signal that sent in downstream for control;
said UEs to read said PDCCH signal for information regarding the drx-dsync-offset and operate in wake-up slots according to the de-synchronization implemented at the MAC unit to start reading the PDCCH signal after a duration of drx-dsync-offset.

In the above system, the RRC set the drx-dsync-offset to an amount that will effectively de-synchronize the wake-up slots and fairly distribute the wake-up times of UEs over multiple slots.

In the above system, the gNB RRC inform the ‘drx-dsync-offset’ via the PDCCH signal only in the ON duration of the DRX cycle such as that the UE cannot wake-up before a certain time which imposes a lower bound LBᵢ on slot number at which a UEᵢ can wake up, whereby communication delay constraint imposes an upper-bound UBᵢ on the slot number at which UEᵢ can wake up satisfying that

$$A = ( {a}_{ij} ) = \{ \begin{matrix}1 & if L {B}_{i} < j < U {B}_{i} \\ 0 & otherwise\end{matrix} ,$$

where (i, j)∈A which provides set of feasible xᵢⱼ binary variable that indicates if the i^{th} UE, UEᵢ is to be active in j^{th} slot.

In the above system, the RRC (700) set the drx-dsync-offset ensuring fairly distributing active UEs among slots based on a fairness index

$$J = \frac{{( {\sum }_{j = 1}^{M} {n}_{j} )}^{2}}{M {\sum }_{j = 1}^{M} {n}_{j}^{2}}$$

where M is the number of slots under consideration and nⱼ=Σᵢxᵢⱼ=Number of active users in slot j.

In the above system, the UEs are configured to clear as much data as possible on waking-up with allocation of resource data more than queued data;
wherein each of the UEs obtain

$$\frac{{R}_{b}}{{\sum }_{j} {x}_{ij}}$$

resource blocks in a slot, where Rᵢⱼ denotes estimated data rate in j^{th} slot and if Cᵢ denotes the total allocated data to UEᵢ, then,

$${C}_{i} = {\sum }_{j = 1}^{M} {x}_{ij} \frac{{R}_{b} {R}_{ij}}{{\sum }_{j} {x}_{ij}}$$

and if the total queued data of UEᵢ is qᵢ, then Cᵢ≥qᵢ.

In the above system, the UEs after waking up, stays ON for multiple consecutive slots to clear its data;
wherein consecutive slot allocations have

$${\sum }_{j = 1}^{M} {x}_{ij} {x}_{ij + 1} = {\sum }_{j = 1}^{M} {x}_{ij} - 1$$

and finally, end up with following with adaptation for de-sync

$$\begin{matrix}{min}_{( i , j ) ∈ A ∩ ( i , k ) ∈ A} {\sum }_{j = 1}^{N} {\sum }_{i = 1}^{N} {\sum }_{k = 1}^{M} {x}_{ik} {x}_{jk} \\ s . t . {C}_{i} = {\sum }_{j = 1}^{M} {x}_{lj} \frac{{R}_{b} {R}_{ij}}{{\sum }_{j} {x}_{ij}} \geq {q}_{i} \\ {\sum }_{j = 1}^{M} {x}_{ij} {x}_{ij + 1} = {\sum }_{j = 1}^{M} {x}_{ij} - 1 \\ {x}_{iM + 1} = 0 ∀ i\end{matrix}$$

which ensures that slot allocation for all XR users is carried out in a manner that maximizes fairness in terms of the number of active XR users per slot and at the same time, it guarantees that all buffered data is cleared, with the additional requirement that the slots allocated to each XR user must be consecutive.

In the above system, the wake-up slots allocation includes heuristic technique, where all UEs are separated into some blocks of size B, and wake-up slots are computed sequentially for all blocks, wherein if a larger block size is selected, a better allocation may be made, but at the expense of a greater computational complexity and operative priority is provided to the UEs who have less schedule freedom when allocating wake-up slots.

In the above system, the wake-up desynchronization includes
involving buffer size qⁱ and average data rate

$${R}_{a v g}^{i}$$

of the UEᵢ to estimate average

$$\frac{{q}^{i}}{{R}_{avg}^{i}}$$

number of slots required to downstream all buffered data of the UEᵢ which corresponds to that the UEᵢ will be active for on average

$$\frac{{q}^{i}}{{R}_{avg}^{i}}$$

number of slots;
setting the drx-dsync-offset to enable the UEᵢ to wakes up at the lower bound then its data transmission terminates at the

$${( {lb}^{i} + \frac{{q}^{i}}{{R}_{avg}^{i}} )}^{th}$$

slot, wherein scheduling freedom is developed based on time interval between the upper bound and the termination of the data transmission if the scheduling is performed at the lower bound is given by

$${ub}^{i} - {lb}^{i} - \frac{{q}^{i}}{{R}_{avg}^{i}} ;$$

sorting all the UEs are first sorted in ascending order of

$${ub}^{i} - {lb}^{i} - \frac{{q}^{i}}{{R}_{avg}^{i}} ,$$

followed by breaking the sorted users set into the batch size of B and go through all batches of UEs and sequentially generate inputs for the UEs of the batch using the brute force method.

According to another aspect in the present invention there is provided a method for wake-up slot de-synchronization in a 5G New Radio (NR) network, comprising:
receiving, at a gNB (gNodeB), DRX parameters including a drx-dsync-offset from an RRC (Radio Resource Control) entity;
implementing, at the gNB's MAC (Medium Access Control) layer, a wake-up slot de-synchronization procedure based on the drx-dsync-offset;
transmitting, via PDCCH (Physical Downlink Control Channel), control information indicative of the drx-dsync-offset to UEs (User Equipments); and
configuring UEs to wake up at times de-synchronized by the drx-dsync-offset.

In the above method, the drx-dsync-offset is dynamically adjusted based on buffer size and average data rate of the UEs to optimize energy efficiency.

The above method comprises the steps of
defining upper and lower bounds for wake-up slot times based on DRX parameters set by an RRC entity at a gNB;
generating an optimization objective function to maximize fairness in distributing active UEs across available slots;
implementing a heuristic or Integer Linear Programming (ILP) technique to allocate wake-up slots to UEs based on the optimization objective function; and
adjusting the wake-up slot allocation dynamically to maintain network performance while ensuring a balance fairness among UEs and energy efficiency.

### BRIEF DESCRIPTION OF THE ACCOMPANYING DRAWINGS

FIG. 1 illustrates (a) Motivation and (b) philosophy of wake-up desynchronization

FIG. 2 illustrates System Modifications in the present invention

FIG. 3 illustrates Implementation Method for invented De-synchronization using C-DRX parameters

FIG. 4 illustrates Upper Bound and Lower bound for De-synchronization

FIG. 5 illustrates Method to perform de-synchronized UE wake-up for energy savings in 5G NR

FIG. 6 illustrates Performance Comparison with traditional C-DRX method for different values of (a) data rate, (b) frame rate, (c) on timer, and (d) inactivity timer: rd-data rate, rf-frame rate, ton-on timer, and tia-inactivity timer, ext-legacy C-DRX, prop-Proposed enhanced C-DRX.

### DETAILED DESCRIPTION OF THE INVENTION WITH REFERENCE TO THE ACCOMPANYING DRAWINGS

The present invention is directed to a technique for saving energy in wireless including 5G user equipment's (UEs). The advancement would have potential to significantly improve energy efficiency which is essential for wireless devices as they are battery operated. The advancement is basically based on the following considerations and scope of developments:

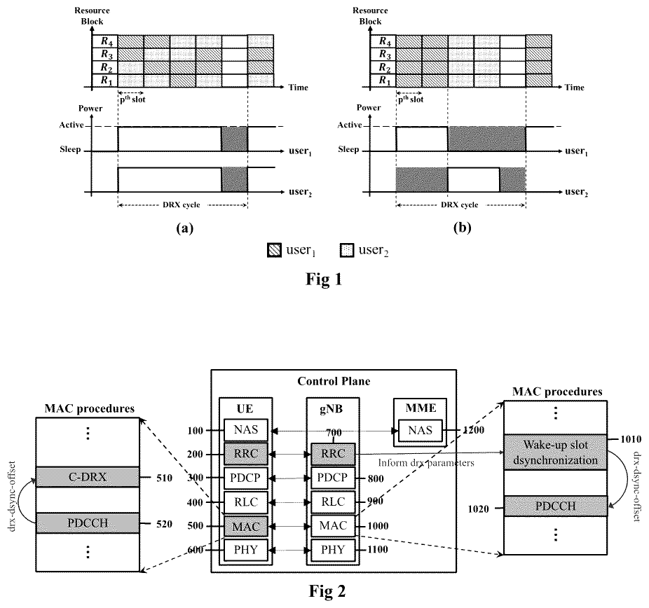

Currently the state-of-the-art technology for saving energy at UE is the C-DRX. Consider two UEs (UE1 and UE2), and both want 8R amount of data to be cleared. The unit R indicates the amount that can be cleared by allocating a resource block to a user. The slot duration is the duration of the resource block and consider that both users wake-up at slot p. As per the allocation shown in FIG. 1 (a), both UEs remain active (in ON state) for 4 slots and gets an opportunity to sleep only for a single slot. In contrast, consider what happens if the UEs wake-up one-by-one and clear its entire data. In this case, UE2 can sleep for the entire duration when UE1 is transmitting and vice-versa. As shown in FIG. 1 (b) this presents an opportunity to increase the sleep duration by two folds. Ideally this improvement factor becomes proportional to the number of UEs, thereby promising a significant increase in case of large number of UE scenarios. However, employing this method implies that some UEs might need to wait for other UEs to complete their transmission leading to large scheduling delays. Hence, there is a trade-off between the energy savings that can be achieved by the proposed scheme and experienced delays. Further, due to the current C-DRX mechanism in place, one can inform the waking-up of the UEs only when they are ON. This therefore requires working modules for saving energy at UE in the C-DRX including conditions of operability under which UEs can be switched ON in a given slot and related developments. The advancement thus is directed to changes in the existing system so that the new method and system based thereon as described above may be implemented. The modules that require changes are shaded in accompanying FIG. 2.

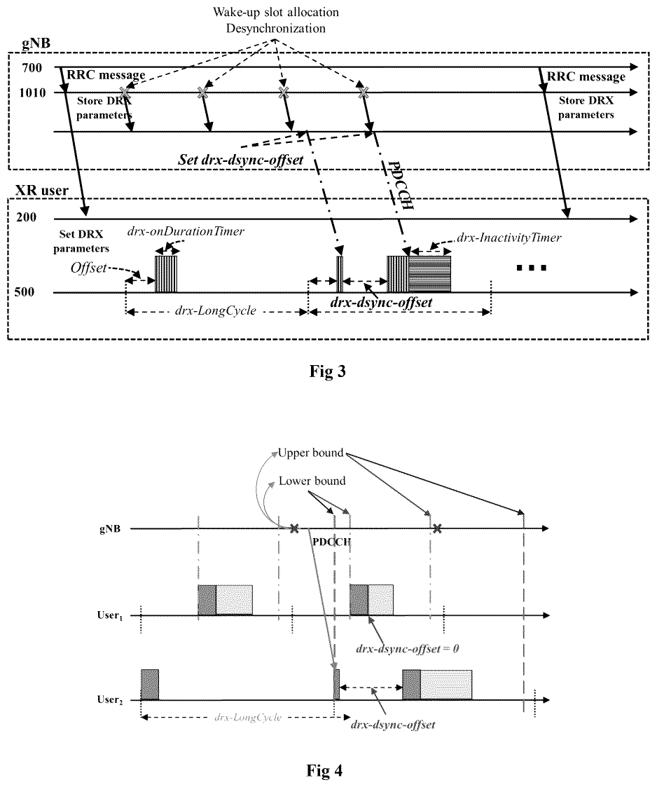

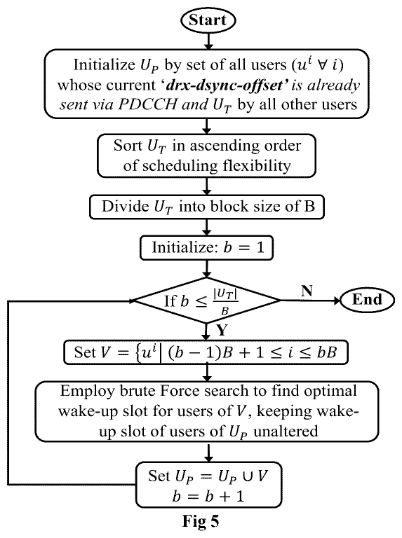

The advancement can be implemented in the network system. First, the method and the system is derived based on the protocol stack and the corresponding elements responsible for implementing the C-DRX mechanism. Importantly, an advanced procedure namely ‘Wake-up slot de-synchronization’ 1010 is implemented at the MAC 1000 of gNB. As shown in FIG. 1, the radio resource control (RRC) 700 is responsible for setting the DRX parameters. To implement de-sync, a new field namely drx-dsync-offset is added to the RRC DRX parameter set. At the gNB side, the RRC 700 sets the drx-dsync-offset and informs the MAC 1000 which then implements the de-synchronization with help of PDCCH 1020 sent in the downstream for control. On reading the PDCCH, the UE is informed regarding the drx-dsync-offset and operates in a fashion shown in FIG. 3. The crossed red points indicate the time instants when the newly introduced procedure operates. By solving an optimization at these instants, the parameter drx-dsync-offset is generated and sent to the UE. On receiving the same, the UE wakes up and starts reading PDCCH after a duration of drx-dsync-offset.

In order to determine the amount of offset, one needs to implement a method that will effectively de-synchronize the wake-up slots. This is achieved by fairly distributing the wake-up times of UEs over multiple slots.

In this section, the advancement includes modules adapted for performing the de-synchronization of wake-up in 5G NR.

According to an aspect of the advancement, the method and system based thereon is developed for performing the de-synchronization of wake-up in 5G NR. By way of exemplary illustration, let xij be a binary variable that indicates if the i^{th} UE is active in the j^{th} slot. The gNB can inform the ‘drx-dsync-offset’ via PDCCH only in the ON duration of the DRX cycle. This implies that the UE cannot wake-up before a certain time which imposes a lower bound on the slot number at which UEᵢ can wake up as shown in FIG. 3. In addition to the lower-bound, the delay constraint imposes an upper-bound on j which is also shown in FIG. 3. Thus, a workable operative is generated based on:
Let UBᵢ and LBᵢ denote the upper and lower bounds and

$$A = ( {a}_{i j} ) = \{ \begin{matrix}1 & if {LB}_{i} < j < {UB}_{i} \\ 0 & otherwise\end{matrix} < {j}_{e} < U {B}_{i}$$

Therefore, have,

$$( i , j ) ∈ A$$

which provides the set of feasible xᵢⱼ.

According to another aspect the objective function and other constraints in the method and system according to the advancement is generated based on:

### Objective Function Generators:

wherein the wake-up de-synchronization addressed the problem of fairly distributing active users among slots. Fairness is typically modeled around a fairness index. One such adaptable popular index is the Jain's fairness index. If M is the number of slots under consideration,

$$\begin{matrix}J = \frac{{( {\sum }_{j = 1}^{M} {n}_{j} )}^{2}}{M {\sum }_{j = 1}^{M} {n}_{j}^{2}} \\ {n}_{j} = {\sum }_{i} {x}_{ij} = Number of ative users in slot j\end{matrix}$$

### Constraints:

a. Ensure Full-buffer Clearance
It is important that UEs to clear as much data as possible on waking-up, which would provide more opportunity for others to sleep. Assuming that the available method/system resource blocks are uniformly allocated among the active users, each user would obtain

$$\frac{{R}_{b}}{{\sum }_{j} {x}_{ij}}$$

resource blocks in a slot. If Rᵢⱼ denotes the estimated data rate in j^{th} slot (estimation is due to variability of the channel) and Cᵢ denotes the total allocated data to UEᵢ, then,

$${C}_{i} = {\sum }_{j = 1}^{M} {x}_{ij} \frac{{R}_{b} {R}_{ij}}{{\sum }_{j} {x}_{ij}} .$$

If the total queued data of UEᵢ is qᵢ, must have:

$${C}_{i} \geq {q}_{i}$$

b. Consecutive Slot Allocation
In addition to the full-buffer clearance constraint, once an UE wakes up, ensure that it stays ON for multiple consecutive slots to clear its data. For consecutive slot allocations have

$${\sum }_{j = 1}^{M} {x}_{ij} {x}_{ij + 1} = {\sum }_{j = 1}^{M} {x}_{ij} - 1$$

Finally, end up with the following:

### Adaptation for De-Sync

$$\begin{matrix}{min}_{( i , j ) ∈ A ∩ ( i , k ) ∈ A} {\sum }_{j = 1}^{N} {\sum }_{i = 1}^{N} {\sum }_{k = 1}^{M} {x}_{ik} {x}_{jk} \\ s . t . {C}_{i} = {\sum }_{j = 1}^{M} {x}_{lj} \frac{{R}_{b} {R}_{ij}}{{\sum }_{j} {x}_{ij}} \geq {q}_{i} \\ {\sum }_{j = 1}^{M} {x}_{ij} {x}_{ij + 1} = {\sum }_{j = 1}^{M} {x}_{ij} - 1 \\ {x}_{iM + 1} = 0 ∀ i\end{matrix}$$

The proposed adaptation is Integer Linear Programming (ILP); hence, brute force search based wake-up slots of all users. However, the primary issue with the brute force search is the requirement of exponential computational complexity, as the wake-up slot allocation is performed very frequently (within a few milliseconds). The computing complexity is significantly decreased if the number of users for whom a wake-up slot is determined can be minimized. Therefore, the advancement proposes heuristic technique, all users are separated into some blocks of size B, and wake-up slots are computed sequentially for all blocks instead of calculating the wake-up slot of all users at once. If a larger block size is selected, a better allocation may be made, but at the expense of a greater computational complexity. The operative prioritizes users who have less schedule freedom when allocating wake-up slots. Let the buffer size and the average data rate of UEᵢ be denoted by qⁱ and

$${R}_{a v g}^{i}$$

respectively. Thus, it is expected that on average

$$\frac{{q}^{i}}{{R}_{avg}^{i}}$$

number of slots would be required to downstream all buffered data of the i^{th} user, i.e., the user will be active for on average

$$\frac{{q}^{i}}{{R}_{avg}^{i}}$$

number of slots. Thus, if the i^{th} user wakes up at the lower bound then its data transmission terminates at the

$${( {lb}^{i} + \frac{{q}^{i}}{{R}_{avg}^{i}} )}^{th}$$

slot. Thus, the scheduling freedom, is developed based on the time interval between the upper bound and the termination of the data transmission if the scheduling is performed at the lower bound is given by

$${ub}^{i} - {lb}^{i} - \frac{{q}^{i}}{{R}_{avg}^{i}}$$

Thus, all users are first sorted in ascending order of

$${ub}^{i} - {lb}^{i} - \frac{{q}^{i}}{{R}_{avg}^{i}} .$$

So, the basic philosophy of the proposed heuristic complexity is as follows:
Sort all users in ascending order of

$${ub}^{i} - {lb}^{i} - \frac{{q}^{i}}{{R}_{avg}^{i}}$$

Break the sorted users set into the batch size of B
Go through all batches of users and sequentially generate inputs for the users of the batch using the brute force method

In accordance with an aspect of the advancement the system configuration can be identified by the shaded modules in FIG. 2. The advancement effectively introduces an additional MAC procedure 1010 “wake-up slot desynchronization” in the 1000 MAC of gNB (refer FIG. 2). The modified functionality of the legacy C-DRX method is also illustrated and the functionality of the advancement proposed in the present method is shown in FIG. 3.

More specifically, in accordance with an aspect of the present advancement the method and system based thereon to perform de-synchronized UE wake up for energy savings in 5G NR is exemplified by way of accompanying FIG. 5.

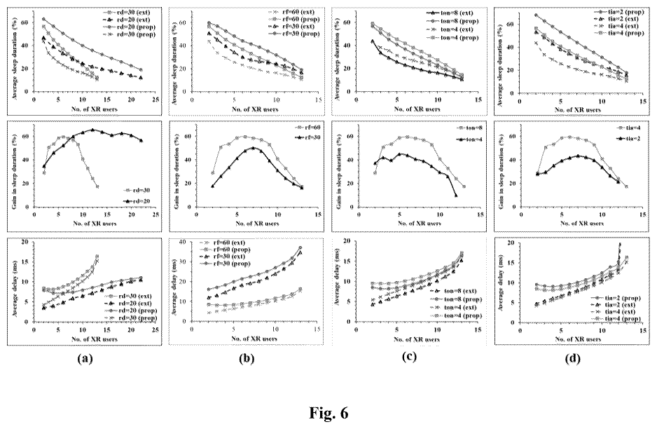

Reference is further invited to accompanying FIG. 6 wherein is illustrated the performance comparison with traditional C-DRX method for different values of (a) data rate, (b) frame rate, (c) on timer, and (d) inactivity timer: rd-data rate, rf-frame rate, ton-on timer, and tia-inactivity timer, ext-legacy C-DRX, prop-Proposed enhanced C-DRX.

It is thus demonstrated how the proposed wake-up desynchronization method enhances the energy efficiency of the C-DRX method. For the purpose, comparative performance of the traditional C-DRX method with the advanced version was carried out, where wake-up desynchronization is integrated atop the traditional C-DRX method. The performance assessment revolves around the average sleep duration (in percentage) and the average delay metrics, in relation to the traffic load (quantified by the number of users). For the purpose it was assumed that all users are XR users in present results, however, this can be relevant for scenarios with different traffic types. The evaluations were carried out for varying values of data rate (30 and 20 Mbps), frame rate (60 and 30 frames per second), drx-onDurationTimer (8 and 4 ms), and drx-InactivityTimer (4 and 2 ms), as depicted in FIG. 6 (a), (b), (c), and (d) respectively.

Results were generated by performing simulations in OMNET++ for a network run time of 100 s. In present simulation, it was considered an area of 1 km×1 km, within which 16 gNBs are placed at equal distances from each other. The user locations are generated using a Poisson point process, with the mean indicated on the x-axis of all the plots. The wireless channel is simulated by following the simplified path loss model and small-scale fading. For the path-loss model, it was considered reference distance d₀=1 m, path loss coefficient γ=3.71. For small-scale fading, it was considered the Rayleigh channel model with 02=1. The C-DRX cycle time assumed to coincide with the inter-frame time. The present XR traffic model adheres to the standards set by the 3GPP group. This XR traffic model characterizes traffic arrivals as pseudo-periodic with added jitter. The jitter follows a truncated Gaussian distribution with mean, standard deviation, minimum, and maximum values of −4 ms, 2 ms, −4 ms, and 4 ms respectively. Further, the packet size also follows truncated Gaussian distribution with a mean of , where r_{d} and r_{f} represent the data rate and frame rate respectively. The standard deviation, minimum, and maximum values for packet sizes are considered to be 10.5%, 50%, and 150% of the mean respectively. In all results, the data rate, frame rate, C-DRX ON Timer, C-DRX Inactivity Timer, batch size (B), and delay bound are considered to be 30 Mbps, 60 fps, 8 ms, 4 ms, 1, and 15 ms respectively, unless they are specified otherwise.

FIG. 6 demonstrates that the novel wake-up desynchronization approach significantly increases sleep duration, thereby enhancing energy efficiency when compared to the conventional C-DRX technique. This improvement arises from the ability of the proposed method to desynchronize the wake-up slots of users. Consequently, when a user awakens, data clearance occurs within a shorter interval, thereby reducing the active duration and enhancing sleep duration. However, achieving wake-up desynchronization necessitates introducing delayed wake-ups for certain users, while satisfying their delay limits. Thus, average delay increases, particularly at low loads where delays are typically low. Nevertheless, as loads increase, delays approach the delay bound. Consequently, the average delay of the proposed method gradually reaches closer to that of the traditional C-DRX technique. This trend can also be seen in FIG. 6.

In FIG. 6, there is also plotted the percentage of enhancement in sleep duration as compared to that of the traditional C-DRX method. The graph clearly displays a remarkable up to 65% improvement in energy efficiency resulting from the desynchronization of wake-up slots. The figure also depicts that, at lower loads, this enhancement becomes more pronounced as the number of users (i.e., load) rises. However, beyond a certain threshold of the number of users, the enhancement in sleep duration diminishes with increasing user count. This is because of the following reasons: At lower loads, the probability of multiple users being simultaneously active within a single slot remains low. The proposed method provides an improvement in energy efficiency by de-synchronizing the active slots of different users. As the number of users rises, the likelihood of multiple users being active in a single slot increases. Consequently, the potential for enhancing energy efficiency through wake-up desynchronization expands, leading to an increase in the percentage enhancement of sleep duration. As the number of users keeps on increasing then beyond a certain threshold, the desynchronization of wake-up slots might lead to breaches in delay bounds for a few XR frames. In the proposed scheme, if a user's XR frame experiences such a delay-bound violation, that user reverts to the traditional C-DRX protocol. As the user count continues to increase, the likelihood of delay-bound violations grows, resulting in a decrement in the feasibility of implementing wake-up desynchronization diminishes. Consequently, the enhancement in sleep duration, as compared to the traditional C-DRX method, diminishes with the increment of the number of users, particularly under heavier loads.

### A. Effect of Data Rate

FIG. 6 illustrates (a) the impact of data rate on both the average sleep duration and average delay for the proposed scheme and the legacy C-DRX method. The figure demonstrates that as the data rate decreases from 30 Mbps to 20 Mbps, both the average sleep duration and average delay reduce for both schemes. This is due to the following reasons: When the data rate decreases while maintaining the same frame rate, it leads to a decrease in the mean frame size (as previously discussed in this section). Consequently, the time required to transmit a frame is shortened, resulting in a reduced active duration. As a result, the average sleep duration and average delay decrease with the decline in the data rate. This figure also displays the improvement in average sleep duration compared to the traditional C-DRX method for data rates of 20 and 30 Mbps. The graph reveals that at lighter loads, the 30 Mbps data rate yields better performance. However, beyond a specific load, the 20 Mbps data rate exhibits superior results. This phenomenon can be explained as follows: With an increase in data rate, the packet size and subsequently the total active duration also increase. This leads to a higher probability of multiple users being active within a single slot. Consequently, the energy efficiency improvement achieved through wake-up desynchronization becomes more pronounced with rising data rates. Nevertheless, when the user count reaches a certain value, the possibility for delay-bound violations arises, particularly for the 30 Mbps data rate. In contrast, the 20 Mbps data rate experiences delay-bound violations at a higher user number due to its shorter packet size and active duration. Hence, beyond a certain user count, the 20 Mbps data rate outperforms the 30 Mbps rate.

### B. Effect of Frame Rate

FIG. 6 portrays (b) the influence of frame rate on energy efficiency and average delay for both the proposed and traditional C-DRX methods. As the frame rate rises, while maintaining a constant data rate, XR users generate larger packets at longer intervals between arrivals, effectively leading to a more bursty traffic pattern. This burstier nature of XR traffic diminishes the probability of multiple users awakening in the same time slot. Consequently, energy efficiency improves for both the traditional C-DRX approach and the proposed scheme of the present invention.

However, in the proposed method of the present invention, which aims to desynchronize wake-up slots, the energy efficiency enhancement due to frame rate reduction is less pronounced compared to the C-DRX method. Consequently, the energy efficiency gain achieved through the proposed scheme diminishes as the frame rate decreases (as shown in FIG. 6(b)). Moreover, the increased burstiness resulting from reduced frame rates contributes to higher average delays, as depicted in FIG. 6(b).

### C. Effect of C-DRX Ontimer

FIG. 6 illustrates (c) the impact of C-DRX ontimer on the average sleep duration and average delay. The graph demonstrates that, as expected, reducing the C-DRX on-timer from 8 ms (equivalent to the jitter interval) to 4 ms leads to an increase in sleep duration for both the traditional C-DRX and the proposed method of the present invention. However, if the C-DRX ontimer is chosen shorter than the jitter interval, frames might arrive after the XR device has entered sleep mode, necessitating their wait until the subsequent C-DRX cycle to be transmitted. This delay results in an increase in average delay, as depicted in the graph. Further, when frames have already encountered substantial delays due to the above scenario, a lesser amount of delay can be introduced to achieve wake-up desynchronization by satisfying the delay bound. Consequently, the potential for wake-up slot desynchronization diminishes when the C-DRX ontimer is set shorter than the jitter interval. This phenomenon leads to a less significant improvement in sleep duration through wake-up desynchronization, as highlighted in FIG. 6(c).

### D. Effect of C-DRX Inactivity Timer

The impact of the C-DRX inactivity timer is depicted in FIG. 6(d). Decreasing the C-DRX inactivity timer prompts users to spend less time prior to entering sleep mode. Consequently, there is a reduction in sleep duration. Thus, the average sleep duration increases as the C-DRX inactivity timer diminishes for both the legacy C-DRX and the proposed method. Moreover, a scenario may arise where a user doesn't acquire any resource block within the inactivity timer window, even if the user's frame transmission isn't yet complete. In such instances, the remaining segment of the frame can only be transmitted in the subsequent C-DRX cycle. As the inactivity timer shortens, the probability of this situation grows. Consequently, a similar impact to the reduction of the C-DRX on-timer (discussed in the subsection C) can be observed.

As would be clearly apparent from the above stated and the exemplary illustrations by way of the accompanying figure-based illustrations, the advancement would provide for a much desired new and advanced manner of saving energy in 5G UE with the potential to save a large amount of energy. Importantly, the system is adapted for the technical efficacy in energy saving and simple and low complexity operatives have been introduced for the effective working of the system.

1. A system for enhancement of Connected mode Discontinuous Reception (C-DRX) energy savings through wake-up Desynchronization of extended reality (XR) user equipments (UEs) under wireless communication comprising: a control unit for gNB and said UEs; said control unit includes:
a gNB radio resource control (RRC) for setting C-DRX parameters which includes drx-dsync-offset and informing MAC unit to implements the de-synchronization with help of a PDCCH signal that sent in downstream for control;
said UEs to read said PDCCH signal for information regarding the drx-dsync-offset and operate in wake-up slots according to the de-synchronization implemented at the MAC unit 1000 to start reading the PDCCH signal after a duration of drx-dsync-offset.

2. The system as claimed in claim 1, wherein the RRC sets the drx-dsync-offset to an amount that will effectively de-synchronize the wake-up slots and fairly distribute the wake-up times of UEs over multiple slots.

3. The system as claimed in claim 1, wherein the gNB RRC informs the ‘drx-dsync-offset’ via the PDCCH signal only in the ON duration of the DRX cycle such as that the UE cannot wake-up before a certain time which imposes a lower bound LBᵢ on slot number at which a UEᵢ can wake up, whereby communication delay constraint imposes an upper-bound UBᵢ on the slot number at which UEᵢ can wake up satisfying that
$$A = ( {a}_{ij} ) = \{ \begin{matrix}1 & if {LB}_{i} < j < {UB}_{i} \\ 0 & otherwise\end{matrix} ,$$
where (i, j)∈A which provides set of feasible xᵢⱼ binary variable that indicates if the i^{th} UE, UEᵢ is to be active in j^{th} slot.

4. The system as claimed in claim 2, wherein the RRC sets the drx-dsync-offset ensuring fairly distributing active UEs among slots based on a fairness index
$$J = \frac{{( {\sum }_{j = 1}^{M} {n}_{j} )}^{2}}{M {\sum }_{j = 1}^{M} {n}_{j}^{2}}$$
where M is the number of slots under consideration and nⱼ=Σᵢxᵢⱼ=Number of active users in slot j.

5. The system as claimed in claim 1, wherein the UEs are configured to clear as much data as possible on waking-up with allocation of resource data more than queued data;
wherein each of the UEs obtain
$$\frac{{R}_{b}}{{\sum }_{j} {x}_{ij}}$$
resource blocks in a slot, where Rᵢⱼ denotes estimated data rate in j^{th} slot and if Cᵢ denotes the total allocated data to UEᵢ, then,
$${C}_{i} = {\sum }_{j = 1}^{M} {x}_{ij} \frac{{R}_{b} {R}_{ij}}{{\sum }_{j} {x}_{ij}}$$
and if the total queued data of UEᵢ is qᵢ, then Cᵢ≥qᵢ.

6. The system as claimed in claim 1, wherein the UEs after waking up, ensure that it stays ON for multiple consecutive slots to clear its data;
wherein consecutive slot allocations have
$${\sum }_{j = 1}^{M} {x}_{ij} {x}_{ij + 1} = {\sum }_{j = 1}^{M} {x}_{ij} - 1$$
and finally, end up with following with adaptation for de-sync
$$\begin{matrix}{min}_{( i , j ) ∈ A ∩ ( i , k ) ∈ A} {\sum }_{j = 1}^{N} {\sum }_{i = 1}^{N} {\sum }_{k = 1}^{M} {x}_{ik} {x}_{jk} \\ s . t . {C}_{i} = {\sum }_{j = 1}^{M} {x}_{ij} \frac{{R}_{b} {R}_{ij}}{{\sum }_{j} {x}_{ij}} \geq {q}_{i} \\ {\sum }_{j = 1}^{M} {x}_{ij} {x}_{ij + 1} = {\sum }_{j = 1}^{M} {x}_{ij} - 1 \\ {x}_{iM + 1} = 0 ∀ i\end{matrix}$$
which ensures that slot allocation for all XR users is carried out in a manner that maximizes fairness in terms of the number of active XR users per slot and at the same time, it guarantees that all buffered data is cleared, with the additional requirement that the slots allocated to each XR user must be consecutive.

7. The system as claimed in claim 6, wherein the wake-up slots allocation includes heuristic technique, where all UEs are separated into some blocks of size B, and wake-up slots are computed sequentially for all blocks, wherein if a larger block size is selected, a better allocation may be made, but at the expense of a greater computational complexity and operative priority is provided to the UEs who have less schedule freedom when allocating wake-up slots.

8. The system as claimed in claim 6, wherein the wake-up desynchronization includes:
involving buffer size qⁱ and average data rate
$${R}_{a v g}^{i}$$
of the UEᵢ to estimate average
$$\frac{{q}^{i}}{{R}_{avg}^{i}}$$
number of slots required to downstream all buffered data of the UEᵢ which corresponds to that the UEᵢ will be active for on average
$$\frac{{q}^{i}}{{R}_{avg}^{i}}$$
number of slots;
setting the drx-dsync-offset to enable the UEᵢ to wakes up at the lower bound then its data transmission terminates at the
$${( {lb}^{i} + \frac{{q}^{i}}{{R}_{avg}^{i}} )}^{th}$$
slot, wherein scheduling freedom is developed based on time interval between the upper bound and the termination of the data transmission if the scheduling is performed at the lower bound is given by
$${ub}^{i} - {lb}^{i} - \frac{{q}^{i}}{{R}_{avg}^{i}} ;$$
sorting all the UEs are first sorted in ascending order of
$${ub}^{i} - {lb}^{i} - \frac{{q}^{i}}{{R}_{avg}^{i}} ,$$
followed by breaking the sorted users set into the batch size of B and go through all batches of UEs and sequentially generate inputs for the UEs of the batch using the brute force method.

9. A method for wake-up slot de-synchronization in a 5G New Radio (NR) network, said method comprises:
receiving, at a gNB (gNodeB), DRX parameters including a drx-dsync-offset from an RRC (Radio Resource Control) entity;
implementing, at the gNB's MAC (Medium Access Control) layer, a wake-up slot de-synchronization procedure based on the drx-dsync-offset;
transmitting, via PDCCH (Physical Downlink Control Channel), control information indicative of the drx-dsync-offset to UEs (User Equipments); and
configuring UEs to wake up at times de-synchronized by the drx-dsync-offset.

10. The method as claimed in claim 9, wherein the drx-dsync-offset is dynamically adjusted based on buffer size and average data rate of the UEs to optimize energy efficiency.

11. The method as claimed in claim 10, further comprises
defining upper and lower bounds for wake-up slot times based on DRX parameters set by an RRC entity at a gNB;
generating an optimization objective function to maximize fairness in distributing active UEs across available slots;
implementing a heuristic or Integer Linear Programming (ILP) technique to allocate wake-up slots to UEs based on the optimization objective function; and
adjusting the wake-up slot allocation dynamically to maintain network performance while ensuring a balance fairness among UEs and energy efficiency.
